(19) United States
(12) Patent Application Publication
(10) Pub. No.: US 2004/0218050 A1
(43) Pub. Date: Nov. 4, 2004

(54) Digital video camera with instant broadcasting capability

(76) Inventors: Yung-Tang Lee, Taipei (TW); Shun-Ping Wang, Taipei (TW)

Correspondence Address: BIRCH STEWART KOLASCH & BIRCH, PO BOX 747, FALLS CHURCH, VA, 22040-0747, US

(21) Appl. No.: 09/838,326

(22) Filed: Apr. 20, 2001

(51) Int. Cl. H04N 5/222

(52) U.S. Cl. 348/207.99

(57) ABSTRACT

A digital video camera which has instant broadcasting capability includes a general portable small size digital video camera linking to a mobile communication network. The digital video camera has a wireless transmission module and a Subscriber Identity Module (SIM) card to enable user to access the digital data services offered by the mobile communication network thereby to transmit recording image and audio data instantly to remote sites without using the SNG facility for achieving onsite and instant broadcasting object.

### FIELD OF THE INVENTION

This invention relates to a digital video camera and particularly a digital video camera that is capable of linking to a mobile communication network for instantly broadcasting the recording image and audio data to remote sites through the mobile communication network.

### BACKGROUND OF THE INVENTION

Accompanying the rapid development in information age, a lot of household appliances also have equipped digital multimedia function and capability. The hottest and most advanced household appliances at present are digital video camera and digital camera. Especially the digital video camera, which has evolved from the earlier analog recording type video cameras of V8 and Hi-8 to the present digital recording type of D8, also called DV, which generally includes Digital Video Camcorder (DVC) and Digital Video Cassette VCR (DV).

The digital video camera can be used for constantly and instantly recording the events happened in people's daily life and to give people lived in the modern time a great deal of amusement and cherished memory. However due to the recording time limitation of the recording medium and power supply, it is still not as convenient as it should be. The presently used recording medium (a special magnetic tape with a width of 6 mm) for digital video camera generally can record only sixty minutes, or ninety minutes when used for recording lower quality image and audio data. When use outdoors and the power supply is depleted, the battery may be replenished or to switch to city power supply for continuous use. However when the recording medium is full and no extra recording medium is readily available, the recording has to stop. This is a situation frequently encountered by many users, i.e. the power supply is available but the recording medium is exhausted.

One of the ways to resolve this problem is to transmit the recording image and audio data instantly and constantly to a remote location for storing or broadcasting. The present digital video devices equipped with this function and capability are professional used equipment such as Satellite News Gathering (SNG) vehicle used by TV station that can transmit field recording image and audio data instantly back to the TV station. This type of video recording system is very bulky and expensive. It is not suitable for general consumers use.

However with rapid innovation and progress in wireless mobile communication network, a lot of digital added value services (such as e-mail transmission, mobile access Internet, and the like) are now available through mobile phone through the mobile communication network. To transmit the digital image recorded by the digital camera through wireless mobile communication network to remote locations still has to link the digital camera to the mobile phone for downloading the digital image stored in the digital camera to the mobile phone, then use the mobile phone to transmit the digital image to remote sites. This is still not a convenient process.

### SUMMARY OF THE INVENTION

The primary object of this invention is to provide a digital video camera that is capable of instantly transmitting recording image and audio data to remote sites to achieve instant onsite broadcasting purpose.

Another object of this invention is to provide a digital video camera that is capable of instantly transmitting the recording image and video data to remote sites for storing thereby to resolve the recording medium shortage problem.

The technique disclosed in this invention is to add mobile communication facilities to the digital video camera to link the mobile communication network. It includes a wireless transmission module and a Subscriber Identity Module (SIM) card. The SIM card is the one presently used in the mobile phone that may be inserted into the digital video camera of this invention whenever user desired for transmitting digital data through the mobile communication network thereby to send the recording image and audio data to remote sites.

The invention, as well as its many advantages, may be further understood by the following detailed description and drawings. The drawings are only to serve for reference and illustrative purpose, and do not intend to limit the scope of the present invention.

### BRIEF DESCRIPTION OF THE DRAWINGS

FIG. 1 is a structural block diagram of this invention.

FIG. 2 is a perspective view of an embodiment of this invention.

FIG. 3 is a schematic view of this invention in use, through a mobile communication network to transmit recording image and audio data to a remote site.

### DESCRIPTION OF THE PREFERRED EMBODIMENT

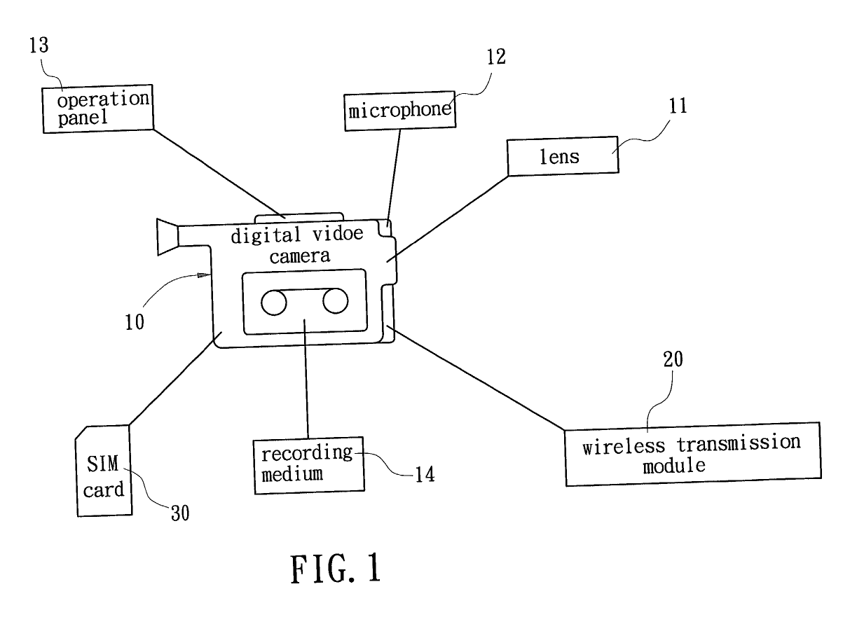

Referring to FIG. 1, in order to achieve the objects set forth above, the digital video camera according to this invention includes the following elements:

a digital video camera 10 which has the function and structure of a general digital video camera for recording object images and sound and store in digital formats. It generally includes a lens 11, a microphone 12, an operation panel 13 (may be a press button type or touch control screen type), and a recording medium 14 (such as a magnetic tape or memory chip);

a wireless transmission module 20 for linking to a wireless mobile communication network (such as GSM system) to transmit the recording image and audio data of the digital video camera 10 to remote sites through a wireless mobile communication network; and

a Subscriber Identity Module (SIM) card 30 which has a chip to store users' Mobile Identity Number (NIM), internal code, password and the like in the GSM mobile phone communication system and allows the registered mobile phone users to use the system.

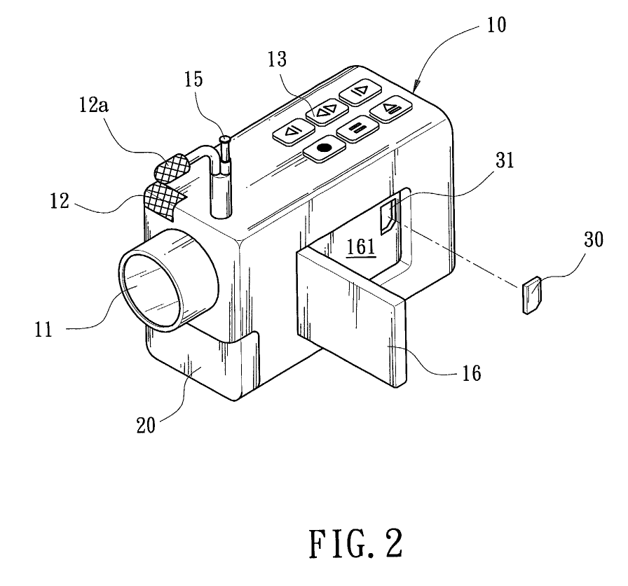

Referring to FIG. 2 for an embodiment of this invention in which the digital video camera 10 equips with aforesaid lens 11, microphone 12, operation panel 13 and recording medium 14. The microphone 12 is a hidden type. In addition, an external high sensitive microphone 12a may also be added. Furthermore, an antenna 15 may also be included in the external microphone 12a for enhancing signal transmission quality between the wireless transmission module 20 and wireless mobile communication network.

Moreover, in the embodiment shown in FIG. 2, an extensible liquid crystal display (LCD) device 16 may be added which may be a monocolor or color type LCD for displaying the image captured by the lens 11. Of course, it also may be a touch control type LCD with the capability for displaying image captured by the lens 11 and operation command icons of the operation panel 13 to facilitate user operation.

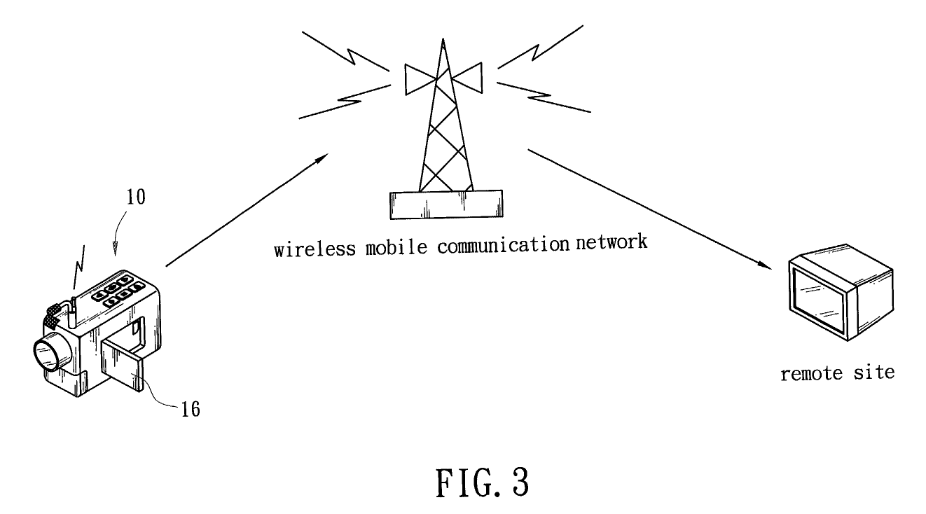

The SIM card 30 is inserted in a socket 31 hidden in the digital video camera 10. The socket 31 may be located in a housing chamber 161 which is also for holding the extensible LCD device 16. When the user extends the LCD device 16, the socket 31 will be exposed for receiving the SIM card 31. During recording operation or after recording is completed, through the operation panel 13 which shows the commands or function for linking to the wireless mobile communication network, user can send the recording image and audio data to remote sites desired (shown in FIG. 3).

By means of the foregoing construction and operation, the digital video camera of this invention can provide instant broadcasting without professional staff or operation skill. A single person can perform instant onsite broadcasting. Coupling with the digital data transmission services offered by the wireless mobile communication network, the recording image and audio data may be transmitted to remote sites through the mobile communication network, such as personal computer in home or TV station, or digital household appliances such as TV. The SIM card is widely used now, thus will make the implementation of this invention even easier.

It may thus be seen that the objects of the present invention set forth herein, as well as those made apparent from the foregoing description, are efficiently attained. While the preferred embodiment of the invention has been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A digital video camera with instant broadcasting capability, comprising:
a digital video camera for recording object image and audio sound and storing the digitized image and audio data;
a wireless transmission module linking to a wireless mobile communication network for the digital video camera to transmit the recording image and audio data to remote sites through the wireless mobile communication network; and
a Subscriber Identity Module (SIM) card for storing users' Mobile Identity Number (MIN), internal code and password for enabling registered users of the wireless mobile communication system to use the wireless mobile communication network.

2. The digital video camera of claim 1, wherein the digital video camera includes a lens, a microphone, an operation panel and a recording medium for storing the image and audio data.

3. The digital video camera of claim 1, wherein the microphone is a hidden microphone.

4. The digital video camera of claim 1, wherein the microphone is an external microphone.

5. The digital video camera of claim 4, wherein the external microphone includes an antenna.

6. The digital video camera of claim 1, wherein the operation panel is a press button type.

7. The digital video camera of claim 1, wherein the operation panel is a touch control screen type.

8. The digital video camera of claim 1 further having an extensible liquid crystal display (LCD) device and a housing chamber for holding the LCD device.

9. The digital video camera of claim 8, wherein the housing chamber has a socket for receiving the SIM card.

10. The digital video camera of claim 1, wherein the wireless transmission module links to a Global System for Mobile communication (GSM) system.
